(19) United States
(12) Patent Application Publication
(10) Pub. No.: US 2005/0147336 A1
(43) Pub. Date: Jul. 7, 2005

(54) Bearing unit and rotary drive apparatus including the bearing unit

(75) Inventors: Yuji Shishido, Kanagawa (JP); Kenichiro Yazawa, Tokyo (JP); Kiyoyuki Takada, Chiba (JP); Toshio Hashimoto, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corp., Tokyo (JP)

(21) Appl. No.: 10/506,561

(22) PCT Filed: Jan. 9, 2004
(86) PCT No.: PCT/JP04/00109

(30) Foreign Application Priority Data
Jan. 10, 2003 (JP) 2003-004927

(51) Int. Cl. F16C 32/06

(52) U.S. Cl. 384/107

(57) ABSTRACT

A reliable bearing unit, in which lubricant does not leak and the problem of shaft lifting at the time of the rotation of a rotor due to the imbalance of a pair of dynamic pressure generating grooves can be surely and inexpensively solved, and a rotary drive apparatus including the bearing unit are provided.

Accordingly, a shaft 100 which has an exposed end 160, an inner end 162 of a small external diameter provided opposite to the exposed end 160, and a stepped middle portion 170 formed between the exposed end 160 and the inner end 162; a thrust bearing 130 which supports the inner end 162 of the shaft 100 in a rotatable manner in the thrust direction; and lubricant 150 in a retention member 120 which is filled between the shaft 100, a radial bearing 110 and the thrust bearing 130 are provided; and the length m of the inner end 162 of the shaft 100 in the direction of the shaft is shorter than the length n in the direction of the shaft of the part between the outer surface of the retention member 120 and the stepped middle portion 170 of the shaft 100.

### TECHNICAL FIELD

The present invention relates to a bearing unit which supports a shaft in a rotatable manner, and to a rotary drive apparatus including the bearing unit.

### BACKGROUND ART

A bearing unit supports a shaft in a rotatable manner, and the bearing unit is provided in a motor of a disk apparatus, for example.

A bearing unit having such structure is the one in which an I-shaped (otherwise called straight-type) shaft is supported in a rotatable manner using lubricant. (Refer to, for example, patent reference 1 and patent reference 2.)

[Patent reference 1]

Japanese Published Patent Application No. 2002-27703 (page 1, FIGS. 1 and 2)

[Patent reference 2]

Japanese Published Patent Application No. H8-335366 (page 1, FIGS. 1 and 2)

### DISCLOSURE OF THE INVENTION

A bearing unit installed in a motor of patent reference 2 is characterized in that the width B1 of a dynamic pressure generating groove on the side of the motor where a rotor portion is installed is larger than the width B2 of a dynamic pressure generating groove on the side where a rotor portion is not installed, as shown in FIG. 2 in patent reference 2.

The purpose of enlarging the width B1 of the dynamic pressure generating groove on the rotor portion side is to improve rigidity when the rotor portion rotates; and also other effectiveness can be obtained as well.

The following is the other effectiveness. A shaft (fixed shaft which does not rotate in this case) and dynamic pressure bearing rotate relatively, and when the dynamic pressure generating grooves generate dynamic pressure, the shaft moves from the high static pressure side to the low static pressure side. In other words, since the shaft moves from the low dynamic pressure side to the high dynamic pressure side, in the case of a motor the shaft is moved in the direction from the narrow dynamic pressure generating groove not capable of generating much dynamic pressure to the broad dynamic pressure generating groove capable of generating a lot of dynamic pressure. Specifically, the shaft is pressed to a thrust bearing due to the relative rotation with the dynamic pressure bearing, so that rigidity is increased.

As regards a motor of Patent reference 2, in order to obtain rigidity when the rotor portion rotates, also the width B1 of a dynamic pressure generating groove on the rotor portion side is larger than the width B2 of a dynamic pressure generating groove on the non rotor portion side in the bearing unit shown in FIG. 1(b).

However, in the case of that motor, the shaft moves from the low dynamic pressure side to the high dynamic pressure side in the manner described above when the shaft rotates, so that the shaft starts to lift concurrently with the rotation.

The power of the dynamic pressure is great enough to lift the rotor portion a great deal, so that regarding a motor for an HDD (hard disk drive) for example, the machine accuracy of the disk and recording head installed in the motor can not be maintained. Thus, problems of not capable of performing normal recording and reproduction are caused. Also, regarding a fan motor or the like, there is a risk of a fan being contact with the surrounding parts.

The bearing units shown in FIGS. 1 and 2 in patent reference 2 are well in relatively changing the widths of the dynamic pressure generating grooves to improve the rigidity of the motors; however, not in the case of a fixed shaft, in the case of the shaft-rotating type there has been disadvantage in which a rotor portion lifts along with a shaft. Specifically, the dynamic pressure must be continuously low on the side where a shaft is exposed from a dynamic pressure bearing.

A dynamic pressure bearing apparatus of patent reference 1 is characterized in that a dynamic pressure generating groove on the shaft-exposing side is herringbone-shaped, and also the depth of half of the groove on the half of the shaft-exposing side is larger than the depth of a groove on the non-exposing side. There is mentioned an advantage in which, when change in a groove is provided regarding one dynamic pressure generating groove, lubricant flows toward the inside of a bearing unit to prevent from leaking. As described above, a shaft moves from the low dynamic pressure side to the high dynamic pressure side, in other words, the shaft is moved toward the inside direction, so that the shaft is pulled effectively also in patent reference 1.

However, since the depth of the dynamic pressure generating groove processed must be controlled with high accuracy by a rolling or transferring method, etching, electric discharging, and the like in the case of patent reference 1, it is difficult in practice to do so, and if it is made, there will be a disadvantage of increasing cost.

Accordingly, in light of the above problems, the present invention aims to provide a bearing unit in which lubricant does not leak to secure the reliability and the problem of shaft lifting at the time of the rotation of a rotor caused due to the imbalance of a pair of dynamic pressure generating grooves can be solved reliably and inexpensively; and to provide a rotary drive apparatus including the bearing unit.

The present invention provides a bearing unit that supports a shaft in a rotatable manner, including: a shaft which has an exposed end, an inner end having a small external diameter provided opposite to the exposed end, and a stepped middle portion having a small external diameter formed at a position between the exposed end and the inner end; a retention member which exposes the exposed end of the shaft to the outside through a gap and has a seamless structure; a bearing disposed inside the retention member, which has a first dynamic pressure generating groove on the exposed end side and a second dynamic pressure generating groove on the inner end side formed on an inner circumferential surface facing the shaft and which supports the shaft in a rotatable manner in the radial direction; a thrust bearing formed inside the retention member, which supports the inner end of the shaft in a rotatable manner in the thrust direction; and lubricant in the retention member, which is filled between the shaft, the radial bearing and the thrust bearing; wherein, the length m of the inner end of the shaft in the direction of the shaft is shorter than the length n in the direction of the shaft of the part between the outer surface of the retention member and the stepped middle portion of the shaft.

According to the present invention, a shaft has an exposed end, an inner end and a stepped middle portion. The inner end is a part having a small external diameter provided opposite to the exposed end. The stepped middle portion is a part having a small external diameter positioned between the exposed end and the inner end.

A retention member exposes the exposed end of the shaft to the outside through a gap and has a seamless structure.

A bearing has a first dynamic pressure bearing and a second dynamic pressure bearing, and supports the shaft in a rotatable manner in the radial direction.

A thrust bearing is formed inside the retention member. The thrust bearing supports the inner end of the shaft in a rotatable manner in the thrust direction.

Lubricant is provided in the retention member and is filled between the shaft, the radial bearing and the thrust bearing.

The length m of the inner end of the shaft in the direction of the shaft is shorter than the length n in the direction of the shaft from the outer surface of the retention member to a part including the stepped middle portion of the shaft.

Therefore, the dynamic pressure of the inner end of the shaft, which is the non shaft-exposing side, can be set higher than the dynamic pressure of the exposed end, which is the shaft-exposing side. Accordingly, the shaft can be formed with ease, and the shaft can be pulled toward the inside of the retention member, so that the problem of the shaft lifting can be solved reliably and inexpensively.

Furthermore, since the lubricant is always pulled toward the inside of the retention member as well and the retention member has a seamless structure, an excellent bearing unit without causing a leakage of lubricant can be provided reliably and inexpensively.

Further, according to the present invention, in the above-described bearing unit, the inner end is a tapered portion or a stepped portion having a small external diameter.

In the present invention, an inner end is a diminishing tapered portion or a stepped portion having a small external diameter.

Further, according to the present invention, in the above-described bearing unit, the external diameter D of the inner end is larger than the external diameter d of the stepped middle portion.

According to the present invention, the external diameter D of an inner end is larger than the external diameter d of a stepped middle portion.

Accordingly, the dynamic pressure on the non shaft-exposing side is made higher than the dynamic pressure on the shaft-exposing side, so that the problems of a shaft lifting and of lubricant leakage can be solved.

Further, according to the present invention, in the above-described bearing unit, the stepped middle portion is a stepped portion formed so that the peripheral portion of the shaft on the exposed end side facing the first dynamic pressure generating groove becomes smaller.

Further, according to the present invention, in the above-described bearing unit, the first and second dynamic pressure generating grooves are herringbone grooves, and the inflow angle α of the first dynamic pressure generating groove is larger than the inflow angle β of the second dynamic pressure generating groove.

According to the present invention, since the inflow angle α of the first dynamic pressure generating groove is larger than the inflow angle β of the second dynamic pressure generating groove, the dynamic pressure of the dynamic pressure generating groove on the non shaft-exposing side can be higher than the dynamic pressure on the shaft-exposing side.

Further, the present invention provides a rotary drive apparatus having a bearing unit that supports a shaft in a rotatable manner, including: a shaft which has an exposed end, an inner end of a small external diameter provided opposite to the exposed end, and a stepped middle portion formed at a position between the exposed end and the inner end; a retention member which exposes the exposed end of the shaft to the outside through a gap and has a seamless structure; a bearing disposed inside the retention member, which has a first dynamic pressure generating groove on the exposed end side and second dynamic pressure generating groove on the inner end side formed on an inner circumferential surface facing the shaft and which supports the shaft in a rotatable manner in the radial direction; a thrust bearing formed inside the retention member, which supports the inner end of the shaft in a rotatable manner in the thrust direction; and lubricant in the retention member, which is filled between the shaft, the radial bearing and the thrust bearing; wherein the length m of the inner end of the shaft in the direction of the shaft is shorter than the length n in the direction of the shaft of the part between the outer surface of the retention member and the stepped middle portion of the shaft.

According to the present invention, a shaft has an exposed end, an inner end and a stepped middle portion. The inner end is a part having a small external diameter provided opposite to the exposed end. The stepped middle portion is a part having a small external diameter positioned between the exposed end and the inner end.

A retention member exposes the exposed end of the shaft to the outside through a gap and has a seamless structure.

A bearing has a first dynamic pressure bearing and second dynamic pressure bearing, and supports the shaft in a rotatable manner in the radial direction.

A thrust bearing is formed inside the retention member. The thrust bearing supports the inner end of the shaft in a rotatable manner in the thrust direction.

Lubricant in the retention member is filled between the shaft, the radial bearing and the thrust bearing.

The length m of the inner end of the shaft in the shaft direction is shorter than the length n in the direction of the shaft from the outer surface of the retention member to a part including the stepped middle portion of the shaft.

Therefore, the dynamic pressure of the inner end of the shaft, which is on the non shaft-exposing side, can be set higher than the dynamic pressure of the exposed end, which is on the shaft-exposing side. Accordingly, the shaft can be made with ease and pulled toward the inside of the retention member, so that the problem of the shaft lifting can be solved reliably and inexpensively.

Furthermore, since the lubricant is always pulled toward the inside of the retention member as well and the retention member has a seamless structure, a rotary drive apparatus having an excellent bearing unit which does not cause lubricant leakage can be provided reliably and inexpensively.

### BRIEF DESCRIPTION OF DRAWINGS

FIG. 1 is a perspective view showing an example of electronic equipment including a bearing unit of the present invention;

FIG. 2 is a cross-sectional view of a fan motor used in FIG. 1;

FIG. 3 is a perspective view of the fan motor shown in FIG. 2;

FIG. 4 is a cross-sectional view showing the fan motor in detail;

FIG. 5 is a cross-sectional view showing the bearing unit in an enlarged scale;

FIGS. 6A and 6B are views showing examples of the shape of a first and second dynamic pressure generating grooves of the bearing unit;

FIG. 7 is a view showing the part A in FIG. 5 in an enlarged scale;

FIG. 8 is a diagram showing an example of the dynamic pressure at the inflow angle in the dynamic pressure generating groove; and

FIG. 9A is a view showing the first dynamic pressure generating groove and FIG. 9B is a view showing an example of the dynamic pressure of the second dynamic pressure generating groove.

### BEST MODE FOR CARRYING OUT THE INVENTION

Hereinafter, embodiments of the present invention will be described in detail based on the accompanying drawings.

It should be noted that since the following embodiments are favorable specific examples, various limitations that are technically preferable are given thereto; however, the scope of the present invention is not limited to those embodiments unless there is a particular description of limiting the present invention in the following explanation.

FIG. 1 shows a portable computer 1 as an example of electronic equipment to which a motor including a bearing unit of the present invention is applied.

The computer 1 has a display portion 2 and a main body 3, and the display portion 2 is joined to the main body 3 in a rotatable manner by means of a joining portion 4. The main body 3 has a keyboard 5 and a chassis 12. In the chassis 12 is provided a heat sink device 10.

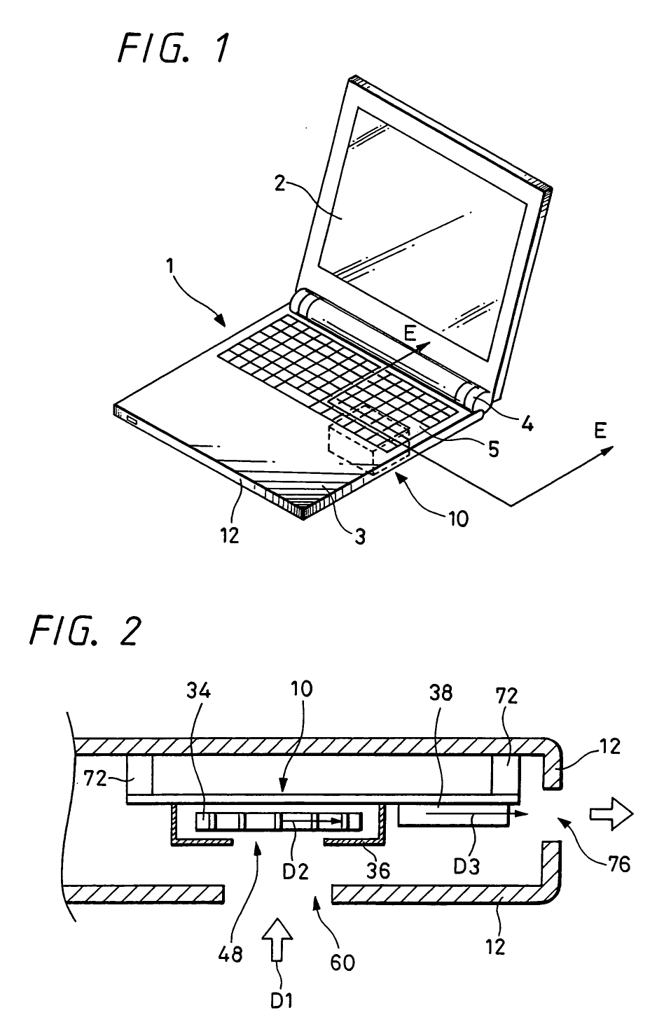

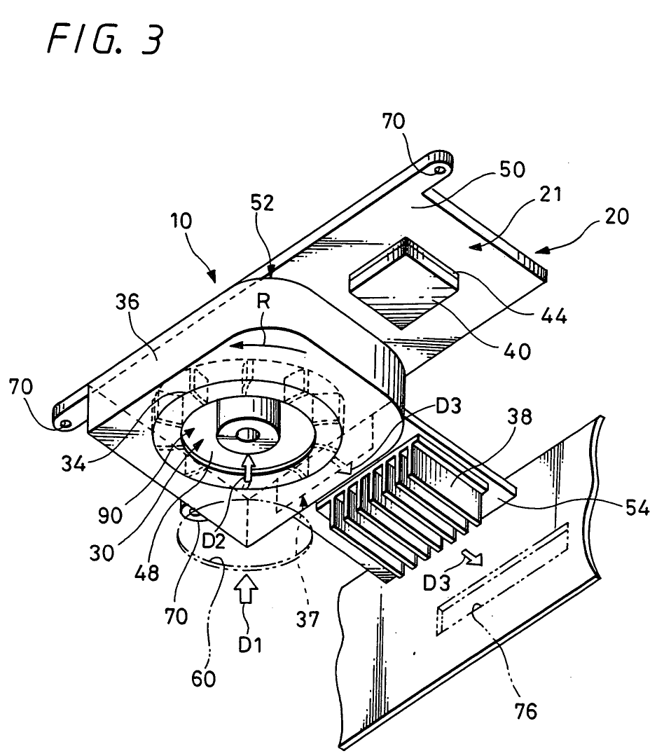

FIG. 2 shows an example of a cross-sectional structure taken by an E-E line of the chassis 12 in FIG. 1. FIG. 3 is a perspective view showing an example of the construction of the heat sink device 10 provided in the chassis 12 shown in FIG. 2.

In FIG. 2, the heat sink device 10 is accommodated in the chassis 12. The heat sink device 10 has a structure shown in FIG. 3. The heat sink device 10, also called a cooling device, has a metal base 20; a motor 30; a fan 34 which is a target object for rotation; a fan case 36; and a heat sink 38.

One surface (corresponding to the lower surface) 21 of the base 20 has a mounting surface 50, a mounting surface 52 and a mounting surface 54. The mounting surfaces 50, 52 and 54 are formed to be, for example, approximately L-shaped, and a heat emitting element 40 is fixed to one surface 21 of the mounting surface 50 with a heat transfer seal 44. The heat emitting element 40 is, for example, a CPU (central processing unit), which emits heat when operated by applying current.

The fan case 36 and the motor 30 are fixed to the mounting surface 52. Inside the fan case 36 are accommodated the fan 34 and the motor 30. The fan case 36 has a circular hole 48. The circular hole 48 is formed at a position facing a hole 60 in the lower surface of the chassis 12 as shown in FIG. 2. The fan case 36 has a hole 37 on the side of the heat sink 38 that is a target object for cooling, to which cooling wind is provided.

The heat sink 38 is fixed to the mounting surface 54. The heat sink 38 is, for example, a corrugated or fin-shaped heat sink, and is made of a metal such as aluminum, for example that is superior in heat dissipation. The base 20 and the fan case 36 can be made of a metal that is superior in heat dissipation such as aluminum or iron.

A hole 70 is provided in necessary positions in the base 20, and the base 20 is fixed with a screw on the inner surface side of the chassis 12 through a boss 72 in FIG. 2, using these mounting holes 70.

The heat sink 38 shown in FIGS. 2 and 3 is provided at a position corresponding to a hole 76 in the side surface of the chassis 12. Accordingly, when the motor 30 is operated to make the fan 34 rotate in the R direction continuously, air inside the chassis 12 is expelled from the hole 76 in the side surface to the outside, via the arrows D1, D2 and D3 after taking in through the holes 60 and 48.

At that time, since heat emitted from the heat emitting element 40 reaches the mounting surface 54 via the mounting surfaces 50 and 52 of the base 20, the heat of the heat emitting element 40 reaches the heat sink 38. A flow of air generated by the rotation of the fan 34 runs along the arrows D1, D2 and D3, and the heat conveyed to the heat sink 38 can be emitted outside through the hole 76 in the side surface of the chassis.

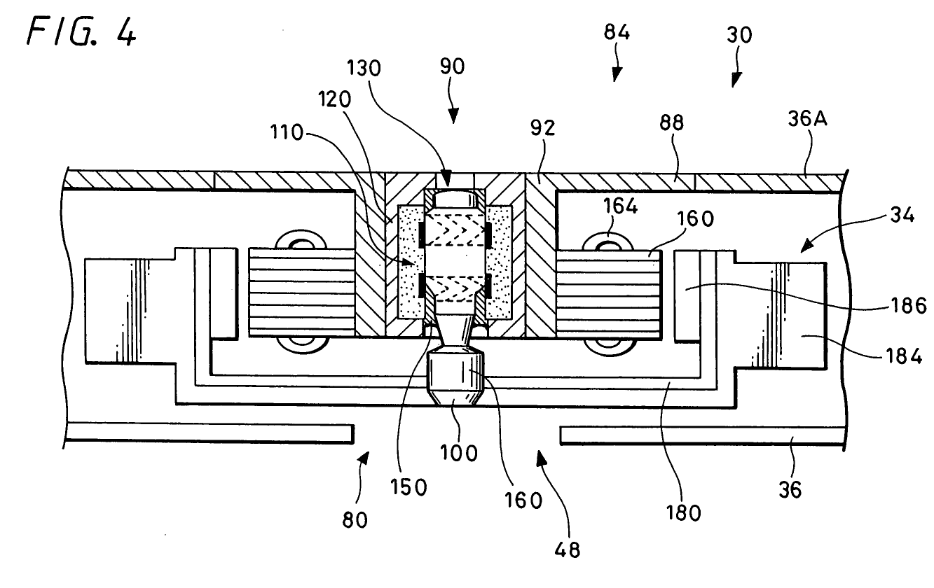

FIG. 4 shows an example of a cross-sectional structure of the motor 30 of FIG. 3. The motor 30 has a rotor 80 and a stator 84.

The motor 30 and the fan 34 are accommodated in the fan case 36, and the stator 84 is integrally provided on the upper surface portion 36A side of the fan case 36. The stator 84 has a stator yoke 88, a bearing unit 90, a coil 164 and a core 160.

The stator yoke 88 may be formed integrally with the upper surface portion 36A of the fan case 36 or may be formed separately, and is made of iron or stainless steel, for example. A housing 120 of the bearing unit 90 is fixed inside a holder 92 of the stator yoke 88 by press fitting or adhesive bonding or by both. The holder 92 is a cylindrical part.

Schematically, the bearing unit 90 shown in FIG. 4 includes a shaft 100, a radial bearing 110, a thrust bearing 130, the retention member (also called housing) 120 and lubricant 150.

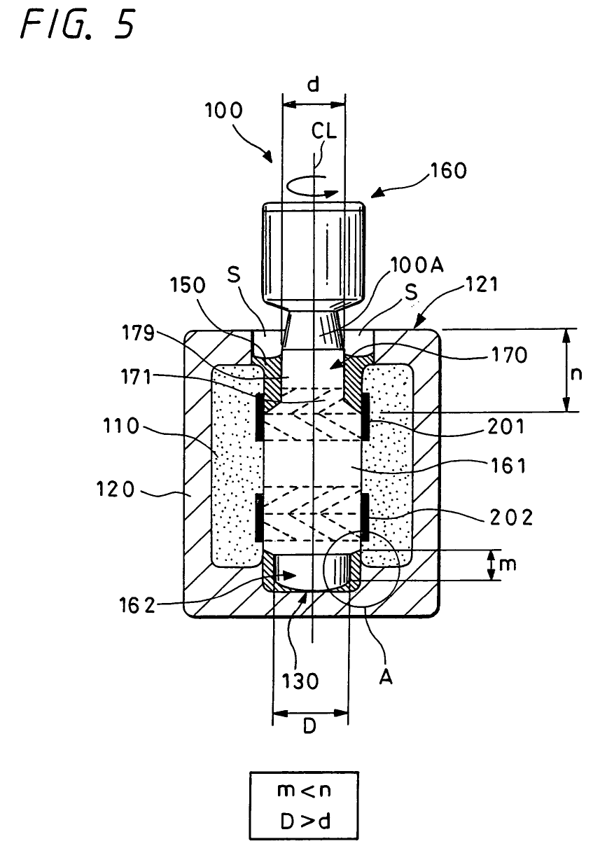

FIG. 5 shows the bearing unit 90 shown in FIG. 4 further in detail. The structure of the bearing unit 90 will be explained in more detail, referring to FIG. 5.

The shaft 100 is a so-called I-shaped (otherwise called straight-type) shaft. The shaft 100 is made of stainless steel, for example.

The shaft 100 has the exposed end 160, a shaft peripheral portion 161, an inner end 162, a stepped middle portion 170 and a tapered portion 100A.

The external diameter of the exposed end 160 can be the same as that of the shaft peripheral portion 161.

The tapered portion 100A is a taper-shaped part positioned between the exposed end 160 and the shaft peripheral portion 161. The tapered portion 100A diminishes in diameter from the shaft peripheral portion 161 toward the exposed end 160. The exposed end 160 is exposed to the outside from a gap S of the retention member 120, and the tapered portion 100A is formed at a position corresponding to the gap S.

The inner end 162 of the shaft 100 is supported by the thrust bearing 130 of the retention member 120 in a rotatable manner in the thrust direction. The shape of the inner end 162 may be such a stepped shape as shown in FIG. 5, or may be a tapered shape, needless to say. In the case of a tapered shape, the inner end 162 has a diminishing tapered shape. The diameter of the inner end 162 is shown by D, and the length of the inner end 162 in the direction of the shaft is shown by m.

As shown in FIG. 5, the stepped middle portion 170 is formed in the middle of the shaft 100. The diameter of the stepped middle portion 170 is shown by d. Preferably, the stepped middle portion 170 is formed of a stepped portion 171, a peripheral portion 179 and a part of the above-described tapered portion 100A.

The diameter D of the inner end 162 is set larger than the diameter d of the peripheral portion 179. Also, the length m of the inner end 162 in the shaft direction is set shorter than the length n of a part from an end surface 121 of the retention member 120 to the stepped middle portion 170 included.

As described above, the external diameter D is set larger than the external diameter d (D>d). Further, preferably the length m of the inner end 162 in the shaft direction is set shorter than the length n of the stepped middle portion 170 in the shaft direction.

Next, the radial bearing 110 shown in FIG. 5 is to be explained.

The radial bearing 110 is a cylindrical member, and supports the shaft peripheral portion 161 of the shaft 100 in a rotatable manner in the radial direction. As an example, a first dynamic pressure generating groove 201 and a second dynamic pressure generating groove 202 are formed at a interval in the inner circumferential surface of the radial bearing 110. The first dynamic pressure generating groove 201 is formed in the vicinity of the stepped middle portion 170, preferably such that they overlap. The second dynamic pressure generating groove 202 is formed on the inner end 162 side. The first dynamic pressure generating groove 201 can be referred to as a dynamic pressure generating groove on the shaft-exposing side. The second dynamic pressure generating groove 202 can be referred to as a dynamic pressure generating groove on the non shaft-exposing side.

The radial bearing 110 can be made of a metal such as brass or stainless steel, a sintered metal, or the like. In the case where a sintered metal or a metal is used, such a dynamic pressure generating groove as a herringbone groove can be formed through a technique such as rolling, transferring, electric discharge, etching processing, and so on.

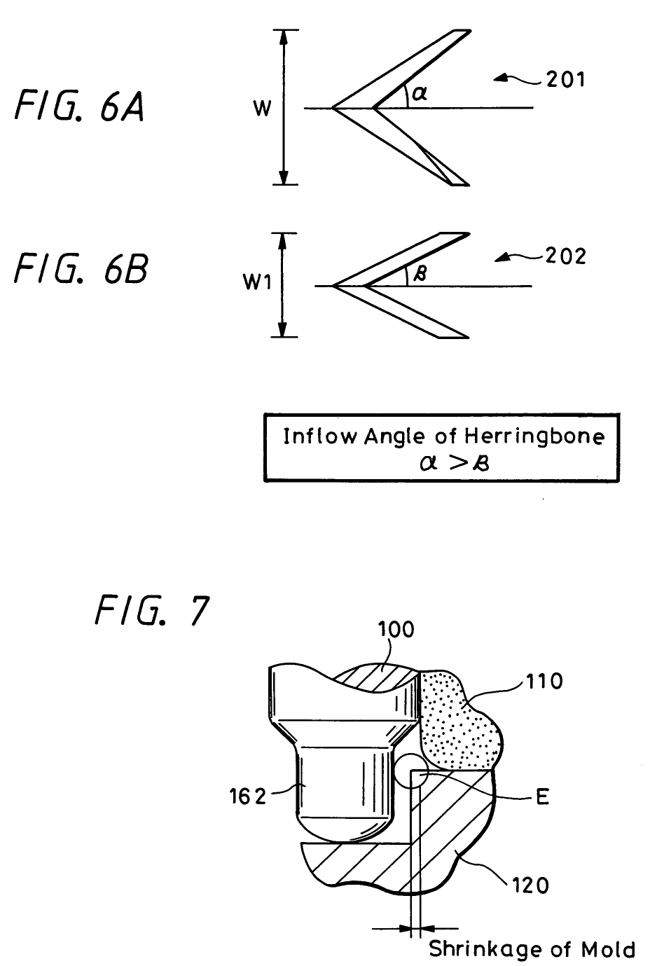

FIG. 6A shows an example of the shape of the first dynamic pressure generating groove 201, and FIG. 6B shows an example of the shape of the second dynamic pressure generating groove 202. It is desirable that the inflow angle α for lubricant of the first dynamic pressure generating groove 201 be set larger than the inflow angle β for lubricant of the second dynamic pressure generating groove 202.

The retention member 120 shown in FIG. 5 is a member of a seamless structure having the gap S. The retention member 120 is not formed by combining a plurality of members but formed by employing a polymeric material such as Teflon®, polyimido, polyamido, LCP (liquid crystalline polymer) or PC (polycarbonate), or a sintered metal, using outsert molding onto the radial bearing 110.

Although the retention member 120 is provided with the tiny gap S as described above, there is a seamless structure around its periphery. The retention member 120 accommodates the radial bearing 110 and the shaft peripheral portion 161 of the shaft 100. The lubricant 150 is filled between the shaft peripheral portion 161, the radial bearing 110 and the retention member 120.

Since the tiny gap S has a cross-section that is a tapered shape, a pressure gradient is generated to form a surface tension seal for lubricant to be pulled inside the bearing unit.

Note that as shown in FIG. 6A, the width W of the first dynamic pressure generating groove 201 in the direction of the shaft is set larger than the width W1 of the second dynamic pressure generating groove 202 shown in FIG. 6B in the direction of the shaft. However, not limited thereto, the width W may be set smaller than the width W1.

Hereupon, advantages obtained by providing magnitude relation between the above-described respective dimensions will be explained.

The dynamic pressure Pd generated when the shaft 100 relatively rotates is proportional to the square of the flow velocity u of lubricant, to be Pd∝u².

Since the flow velocity u is proportional to the relative velocity U of the shaft 100 and is inversely proportional to the amount h of the gap between the shaft 100 and the radial bearing 110, to be u∝U/h. Here, U=rω, r: shaft radius, ω: shaft rotation speed is obtained.

Specifically, since the dynamic pressure Pd is virtually proportional to the square of the shaft radius r and is inversely proportional to the square of the amount c of the gap between the shaft and the bearing, Pd∝(r/c) is obtained.

As a result, the smaller the external diameter of the shaft is made, the more the generation of dynamic pressure can be reduced.

In the bearing unit 90 of FIG. 5 in the present invention, since the stepped portion of the inner end 162 on the non shaft-exposing side is shorter in shaft length (m<n) and also is larger in shaft diameter (D>d) than the stepped middle portion 170 on the shaft-exposing side as shown in FIG. 5, the dynamic pressure on the shaft-exposing side is always lower.

Moving from the low dynamic pressure side to the high dynamic pressure side, the shaft 100 is pulled toward the thrust bearing 130 inside the retention member 120 and therefore never lifts.

Furthermore, in order to prevent the shaft 100 in FIG. 5 from lifting, the stepped middle portion 170 is provided at the part of the shaft 100 facing the first dynamic pressure generating groove 201 so that the dynamic pressure of the second dynamic pressure generating groove 202 on the non shaft-exposing side becomes higher than the dynamic pressure of the first dynamic pressure generating groove 201 on the shaft-exposing side.

Further, by providing the stepped middle portion 170, not only the dynamic pressure of the first dynamic pressure generating groove 201 on the shaft-exposing side becomes smaller than that of the second dynamic pressure generating groove 202 on the non shaft-exposing side, but also the first dynamic pressure generating groove 201 itself on the shaft-exposing side can make the shaft-exposing side to have lower dynamic pressure, and the shaft 100 can be prevented from lifting even more reliably and inexpensively. In other words, the inner end 162 and the stepped middle portion 170 can be made with ease on the shaft.

In prior art, it is attempted to reduce the dynamic pressure on the shaft-exposing side by changing the depth of a dynamic pressure generating groove, so that oil flow toward the inside, as described above. In the bearing unit of the present invention, however, since the external diameter of the shaft 100 is changed to obtain the change of the dynamic pressure, it is possible to produce the bearing unit by far more simplified and inexpensive manner, and to obtain the same effectiveness reliably.

To briefly explain the above-described effectiveness, when the dynamic pressure on the shaft-exposing side and the dynamic pressure on the non shaft-exposing side are compared, the pressure on the shaft-exposing side is low according to the shape of the shaft 100, and the shaft-exposing side thereof is low according to the dynamic pressure generating groove. Hence, the dynamic pressure of the shaft-exposing side is set low in every respect, so that the shaft can be reliably prevented from lifting. To put it another way, the bearing unit 90 can reliably make lubricant flow into the bearing unit to be retained and is provided inexpensively with much reliability.

Hereupon, the necessity of providing a stepped part as the inner end 162 on the non shaft-exposing side shown in FIG. 5 will further be explained.

Conventionally, in order to prevent lubricant from leaking, a plurality of members are used to surround a bearing unit; however, since it has not been easy to seal joints thereof, it has been necessary to apply a packing agent such as epoxy resin or has required other means, so that the cost became high and unreliability were inevitable.

In the bearing unit 90 of the present invention, the surrounding retention member 120 is formed by making a polymeric material such as LCP undergo outsert molding and is made completely seamless except for the surface tension seal portion in the gap S portion to be provided inexpensively and reliably.

However, as shown in FIG. 7, the temperature of the retention member 120 returns to a normal temperature after outsert molding is performed on resin at a high temperature, for example, approximately between 100° C. to 250° C. At that time, an edge E of the retention member 120 slightly projects on the inner circumferential side of the radial bearing 110 due to a difference between the contraction percentage of the radial bearing 110 made of a sintered metal or the like and that of the retention member 120 made of a polymeric material. In order to avoid the edge E coming to contact with the shaft 100, a contact-prevention means such as the stepped portion of the inner end 162 of the shaft 100 or a tapered shape is necessary.

Specifically, if the seamless retention member 120 made of a polymeric material is used for completely preventing lubricant from leaking, the contact-prevention means such as the stepped portion of the inner end 162 or the like is needed, and as a result, the dynamic pressure generated based on the shape of the shaft needs to be adjusted, so that a structure according to the present invention is required.

However, the purpose of the bearing unit 90 of the present invention is to prevent the shaft from lifting, so that the structure of the retention member may not be limited at all.

As shown in FIGS. 6A and 6B, in order to make the dynamic pressure on the shaft-exposing side relatively lower than the dynamic pressure on the non shaft-exposing side, the dynamic pressure generating grooves 201 and 202 are made to be of a herringbone type, and further, the herringbone inflow angles α and β can be favorably selected.

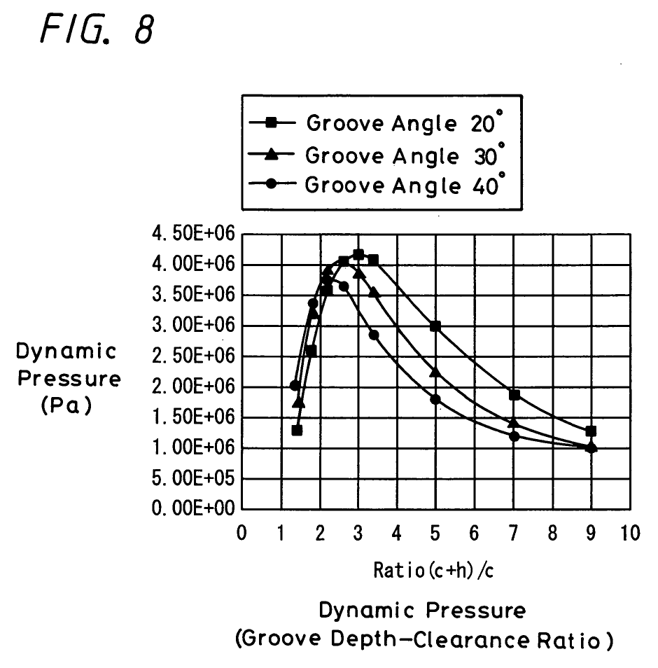

FIG. 8 shows calculation results of the dynamic pressure when the inflow angle of the herringbone groove was 20°, 30° and 40° respectively. The horizontal axis shows the ratio of the amount c of the gap between the shaft 100 and the radial bearing 110 to the sum of the gap amount c and the depth h of the herringbone groove, (h+c)/c. The vertical axis shows the dynamic pressure generated.

The larger the inflow angle becomes, reaching 30° and 40° , compared to the case of the inflow angle of 20° the lower the dynamic pressure becomes, so that by making the inflow angle α of the first dynamic pressure generating groove 201 on the shaft-exposing side larger than the inflow angle β of the second dynamic pressure generating groove 202 on the non shaft-exposing side, even more reliably the shaft 100 can be prevented from lifting.

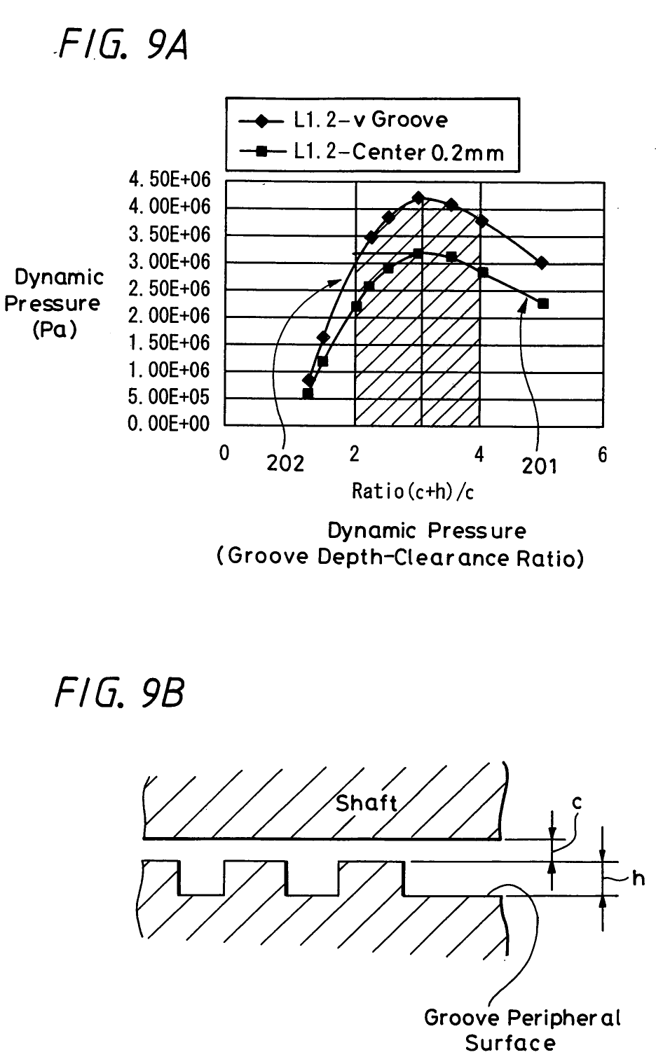

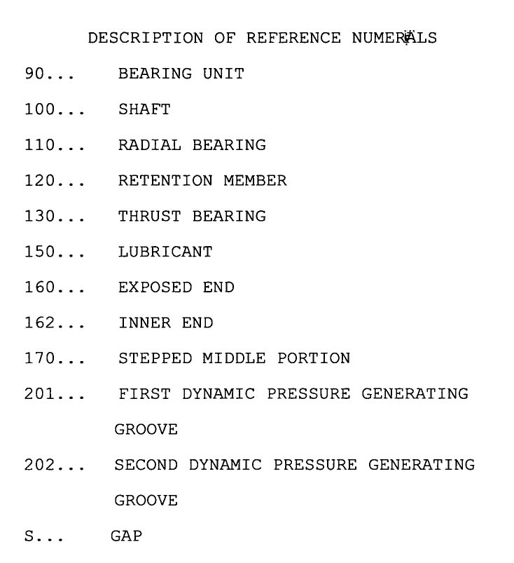

Referring to FIGS. 9A and 9B, specific examples of the structural design are further described.

In FIG. 9A, the horizontal axis shows the ratio of the gap amount c to the sum of the gap amount c and the depth h of the herringbone groove, (c+h)/c, and the vertical axis shows the dynamic pressure. The gap amount c and the groove depth h are shown in FIG. 9B.

One of the characteristic curves shows the dynamic pressure of the first dynamic pressure generating groove 201 on the shaft-exposing side, and the other shows the dynamic pressure of the second dynamic generating groove 202 on the non shaft-exposing side.

Here, even if the machine-made dimensions of the gap amount c and the groove depth h are widely varied, the dynamic pressure on the non shaft-exposing side must be higher than the dynamic pressure on the shaft-exposing side invariably.

For example, if the gap amount c=1 to 2 μm and the groove depth h=2 to 3 μm is set, (c+h)/c becomes (2+2)/2=2 in minimum value and becomes (1+3)/1=4 in maximum value, so that within the range for use marked by oblique lines in FIG. 9A, the dynamic pressure of the second dynamic pressure generating groove 202 on the non-exposing side is always kept higher than the dynamic pressure of the first dynamic pressure generating groove 201, and therefore the problem of the shaft lifting caused by the dispersion resulting from machine accuracy cannot occur.

Therefore, the above-described various improvements should be made so that the dynamic pressure on the non shaft-exposing side becomes invariably higher than the dynamic pressure on the shaft-exposing side.

As described above, the bearing unit of the present invention has the following advantages.

According to the bearing unit 90 of the present invention, the dynamic pressure on the non shaft-exposing side is set higher than the dynamic pressure on the shaft-exposing side. Specifically, the dynamic pressure of the second dynamic pressure generating groove 202 on the non shaft-exposing side is set higher than that of the first dynamic pressure generating groove 201 on the shaft-exposing side, by providing the stepped middle portion 170 on the shaft facing the first dynamic pressure generating groove 201 on the shaft-exposing side and by varying the inflow angles α and β.

As regards the distribution of the dynamic pressure of the dynamic pressure generating groove itself on the shaft-exposing side, the dynamic pressure on the non shaft-exposing side is set higher than that on the shaft-exposing side, so that the dynamic pressure on the non shaft-exposing side becomes higher than the dynamic pressure on the shaft-exposing side, without fail.

As a result, the shaft 100 in FIG. 5 is pulled toward the inside of the retention member 120, so that the problem of the shaft 100 lifting never happens. The lubricant 150 is always made to flow toward the inside as well, and further, as surrounded by the seamless retention member 120, a reliable bearing unit can be inexpensively provided in which lubricant is prevented from leaking.

In addition, the bearing unit of the present invention is used as a bearing unit of a so-called fan motor, as shown in FIGS. 1 to 3. A fan motor is a kind of a rotary drive apparatus. The bearing unit according to the present invention can be used needless to say as a bearing of a pump apparatus or a disk drive apparatus, for example, a hard disk drive apparatus, an optical disk apparatus or a magneto optical disk apparatus, which are other examples of a rotary drive apparatus.

As described above, according to the present invention, lubricant does not leak, reliability can be enhanced, and also the problem of shaft defect at the time of the rotation of a rotor caused by the imbalance of a pair of dynamic pressure generating grooves can be solved reliably and inexpensively.

1. A bearing unit that supports a shaft in a rotatable manner, comprising:
a shaft including an exposed end, an inner end having a small external diameter provided opposite to said exposed end, and a stepped middle portion having a small external diameter formed at a position between said exposed end and said inner end;
a retention member which exposes said exposed end of said shaft to the outside through a gap and has a seamless structure;
a bearing disposed inside said retention member, which has a first dynamic pressure generating groove on said exposed end side and second dynamic pressure generating groove on said inner end side formed on an inner circumferential surface facing said shaft and which supports said shaft in a rotatable manner in the radial direction;
a thrust bearing formed inside said retention member, which supports said inner end of said shaft in a rotatable manner in the thrust direction; and
lubricant in said retention member, which is filled between said shaft, said radial bearing and said thrust bearing; wherein
the length m of said inner end of said shaft in the direction of the shaft is shorter than the length n in the direction of the shaft of the part between the outer surface of said retention member and said stepped middle portion of said shaft.

2. A bearing unit according to claim 1, wherein said inner end is a diminishing tapered portion or a stepped portion having a small external diameter.

3. A bearing unit according to claim 2, wherein the external diameter D of said inner end is larger than the external diameter d of said stepped middle portion.

4. A bearing unit according to claim 3, wherein said stepped middle portion is a stepped portion formed such that the peripheral portion of said shaft facing said first dynamic pressure generating groove becomes smaller on said exposed end side.

5. A bearing unit according to claim 1, wherein said first and second dynamic pressure generating grooves are herringbone grooves, and the inflow angle α of said first dynamic pressure generating groove is larger than the inflow angle β of said second dynamic pressure generating groove.

6. A rotary drive apparatus having a bearing unit which supports a shaft in a rotatable manner, comprising:
a shaft including an exposed end, an inner end of a small external diameter provided opposite to said exposed end, and a stepped middle portion formed at a position between said exposed end and said inner end;
a retention member that exposes said exposed end of said shaft to the outside through a gap and has a seamless structure;
a bearing disposed inside said retention member, which has a first dynamic pressure generating groove on said exposed end side and second dynamic pressure generating groove on said inner end side formed on an inner circumferential surface facing said shaft and which supports said shaft in a rotatable manner in the radial direction;
a thrust bearing formed inside said retention member, which supports said inner end of said shaft in a rotatable manner in the thrust direction; and
lubricant in said retention member, which is filled between said shaft, said radial bearing and said thrust bearing; wherein
the length m of said inner end of said shaft in the direction of the shaft is shorter than the length n in the direction of the shaft of the part between the outer surface of said retention member and said stepped middle portion of said shaft.
